(19) United States
(12) Patent Application Publication
(10) Pub. No.: US 2008/0274884 A1
(43) Pub. Date: Nov. 6, 2008

(54) Novel use of (N'-methyl)benzoylurea compound

(76) Inventors: Norihisa Sakamoto, Sanda-shi (JP); Masato Konobe, Toyonaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/081,663

(22) Filed: Apr. 18, 2008

(30) Foreign Application Priority Data
Apr. 19, 2007 (JP) 2007-110171

(51) Int. Cl. A01N 25/26; A01N 47/28

(52) U.S. Cl. 504/100; 514/598

(57) ABSTRACT

A method for preventing a plant such as vegetables, corn, cotton, rice, sugar beet or soybean from damage by insect pest after germination of the plant which comprises steps of treating seeds of the plant with a composition containing a (N′-methyl)benzoylurea compound represented by the formula (I):

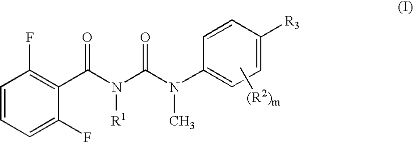

wherein R¹ denotes a hydrogen atom or the like, R² denotes a halogen atom or the like, R³ denotes a halogen atom, an optionally halogenated C1-C4 alkyl group, or the like, and sowing the treated seeds, followed by cultivation.

### BACKGROUND OF THE INVENTION

1. Technical Field

The present invention relates to a novel use of a certain (N′-methyl)benzoylurea compound for treatment of seeds of a plant such as vegetables, corn, cotton, rice, sugar beet, or soybean for preventing the plant from insect pests which cause damages on the plant after germination.

2. Background Art

It has been know that benzoylurea compounds whose substituent at N′ position of the benzoylurea is a hydrogen atom are effective for preventing plants from insect pests and can be used as efficacious components of seed treatment agents (see JP 01-168661 A and JP 11-240859 A).

### SUMMARY OF THE INVENTION

The present invention provides novel use of a certain (N′-methyl)benzoylurea compound for treatment of seeds of a plant for prevention of the plant from insect pests which cause damages on the plant after germination.

The present inventors have studied intensively and have completed the present invention.

That is, the present invention provides:

(1) A method for preventing a plant from damage by insect pests after germination of the plant which comprises the steps of:

treating seeds of the plant with a composition comprising a (N′-methyl)benzoylurea compound represented by the formula (I):

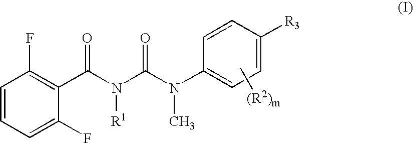

wherein R¹ denotes a hydrogen atom, an optionally halogenated C1-C6 alkyl group, an optionally halogenated C2-C6 alkenyl group, a C2-C6 alkynyl group, a C6-C14 aryl group, a C7-C11 aralkyl group, a C2-C6 alkoxyalkyl group, a C7-C14 aryloxyalkyl group, a C3-C6 dialkylaminoalkyl group, a C2-C6 alkylthioalkyl group, a C2-C6 alkylthioalkyl group, a C2-C6 alkylsulfinylalkyl group, a C2-C6 alkylsulfonylalkyl group, a C3-C9 alkoxyalkoxyalkyl group, a C2-C6 alkoxycarbonyl group, a C8-C12 aralkyloxycarbonyl group, a C3-C13 dialkylcarbamoyl group, an optionally halogenated C2-C6 alkylcarbonyl group, a formyl group, an optionally halogenated C1-C5 alkylsulfonyl group, or a C6-C10 arylsulfonyl group, R² denotes a halogen atom or an optionally halogenated C1-C4 alkyl group; R³ denotes a halogen atom, an optionally halogenated C1-C4 alkyl group, an optionally halogenated C1-C4 alkoxy group, an optionally halogenated C2-C6 alkoxyalkoxy group, an optionally halogenated C2-C4 alkenyloxy group, or an optionally halogenated C2-C4 alkynyloxy group, and m denotes an integer of 0 to 4, and

sowing the treated seeds, followed by cultivation;

(2) The method according to the above (1), wherein the plant is selected from the group consisting of vegetables, corn, cotton, rice, sugar beet and soybean;

(3) A method for producing treated seeds of a plant which comprises subjecting the seeds to a treatment with a composition comprising the (N′-methyl)benzoylurea compound represented by the formula (I) as defined in the above (1) so as to prevent the plant from damage by insect pests after germination;

(4) The method according to the above (3), wherein the plant is selected from the group consisting of vegetables, corn, cotton, rice, sugar beet and soybean;

(5) A composition for treating seeds of a plant so as to prevent the plant from damage by insect pests after germination comprising the (N′-methyl)benzoylurea compound represented by the formula (I) as defined in the above (1);

(6) The composition according to the above (5), wherein the plant is selected from the group consisting of vegetables, corn, cotton, rice, sugar beet and soybean;

(7) Seeds of a plant which are treated with a composition containing the (N′-methyl)benzoylurea compound represented by the formula (I) as defined in the above (1);

(8) The seeds according to the above (7), wherein the plant is selected from the group consisting of vegetables, corn, cotton, rice, sugar beet and soybean;

(9) Use of the (N′-methyl)benzoylurea compound represented by the formula (I) as defined in the above (1) for treatment of seeds of a plant so as to prevent the plant from damage by insect pests after germination;

(10) The use according to the above (9), wherein the plant is selected from the group consisting of vegetables, corn, cotton, rice, sugar beet and soybean; and the like.

Treatment of seeds of a plant with the (N′-methyl)benzoylurea compound represented by the formula (I) (hereinafter, referred to as the present compound) can prevent the plant from damage by insect pests after germination of these plants.

### DETAILED DESCRIPTION OF THE INVENTION

Examples of the substituent denoted by R¹ in the present compound are as follows.

Examples of “an optionally halogenated C1-C6 alkyl group” include methyl, chloromethyl, difluoromethyl, trichloromethyl, ethyl, 2-bromoethyl, 2,2,2-trifluorethyl, propyl, 3,3,3-trifluoropropyl, isopropyl, butyl, isobutyl, sec-butyl, tert-butyl, 4,4,4-trifluorobutyl, pentyl, isopentyl, neopentyl, 5,5,5-trifluoropentyl, hexyl, and 6,6,6-trifluorohexyl.

Examples of “an optionally halogenated C2-C6 alkenyl group” include vinyl, 1-propenyl, 2-propenyl, isopropenyl, 2-butenyl, isobutenyl, and 3,3-dichloro-2-propenyl.

Examples of “a C2-C6 alkynyl group” include ethinyl, 2-propinyl, and 1-propinyl.

Examples of “a C6-C14 aryl group” include phenyl, 1-naphthyl, 2-naphthyl, and biphenyl.

Examples of “a C7-C11 aralkyl group” include benzyl and phenethyl.

Examples of “a C2-C6 alkoxyalkyl group” include methoxymethyl, ethoxymethyl, 1-propoxymethyl, 2-methoxyethyl, 2-ethoxyethyl, 3-methoxypropyl, and 3-ethoxypropyl.

Examples of “a C7-C14 aryloxyalkyl group” include phenoxymethyl and 2-phenoxyethyl.

Examples of “a C3-C6 dialkylaminoalkyl group” include dimethylaminomethyl, 2-(dimethylamino)ethyl, diethylaminomethyl, and 2-(diethylamino)ethyl.

Examples of “a C2-C6 alkylthioalkyl group” include methylthiomethyl, ethylthiomethyl, 2-(methylthio)ethyl, and 2-(ethylthio)ethyl.

Examples of “a C2-C6 alkylsulfinylalkyl group” include methylsulfinylmethyl, ethylsulfinylmethyl, 2-(methylsulfinyl)ethyl, and 2-(ethylsulfinyl)ethyl.

Examples of “a C2-C6 alkylsulfonylalkyl group” include methylsulfonylmethyl, ethylsulfonylmethyl, 2-(methylsulfonyl)ethyl, and 2-(ethylsulfonyl)ethyl.

Examples of “a C3-C9 alkoxyalkoxylalkyl group” include (2-methoxyethoxy)methyl.

Examples of “a C2-C6 alkoxycarbonyl group” include methoxycarbonyl, ethoxycarbonyl, n-propoxycarbonyl, isopropoxycarbonyl, n-butoxycarbonyl, and tert-butoxycarbonyl.

Examples of “a C8-C12 aralkyloxycarbonyl group” include benzyloxycarbonyl.

Examples of “a C3-C13 dialkylcarbamoyl group” include dimethylcarbamoyl and diethylcarbamoyl.

Examples of “an optionally halogenated C2-C6 alkylcarbonyl group” include acetyl, propionyl, trifluoroacetyl, and chloroacetyl.

Examples of “an optionally halogenated C1-C5 alkylsulfonyl group” include methanesulfonyl, ethanesulfonyl, and trifluoromethanesulfonyl.

Examples of “a C6-C10 arylsulfonyl group” include benzenesulfonyl and toluenesulfonyl.

Examples of the substituent denoted by R² in the present compound are as follows.

Examples of “a halogen atom” include a fluorine atom, a chlorine atom, a bromine atom, and an iodine atom.

Examples of “an halogenated C1-C4 alkyl group” include methyl, chloromethyl, difluoromethyl, trichloromethyl, trifluoromethyl, ethyl, 2-bromoethyl, 2,2,2-trifluoroethyl, pentafluoroethyl, propyl, 3,3,3-trifluoropropyl, isopropyl, butyl, isobutyl, sec-butyl, tert-butyl, and 4,4,4-trifluorobutyl.

Examples of the substituent denoted by R³ in the present compound are as follows.

Examples of “a halogen atom” include a fluorine atom, a chlorine atom, a bromine atom, and an iodine atom.

Examples of “an optionally halogenated C1-C4 alkyl group” include methyl, chloromethyl, difluoromethyl, trichloromethyl, trifluoromethyl, ethyl, 2-bromoethyl, 2,2,2-trifluoroethyl, pentafluoroethyl, propyl, 3,3,3-trifluoropropyl, isopropyl, butyl, isobutyl, sec-butyl, tert-butyl, and 4,4,4-trifluorobutyl.

Examples of “an optionally halogenated C1-C4 alkoxy group” include methoxy, ethoxy, 1-propyloxy, isopropoxy, tert-butoxy, difluoromethoxy, trifluoromethoxy, 2,2,2-trifluoroethoxy, 1,1,2,2,2-pentafluoroethoxy, 1,1,2,2-tetrafluoroethoxy, 1,1,2,2,3,3,3-heptafluoro-1-propoxy, and 1,1,2,3,3,3-hexafluoro-1-propoxy.

Examples of “an optionally halogenated C2-C6 alkoxyalkoxy group” include 2-trifluoromethoxy-1,1,2-trifluoroethoxy.

Examples of “an optionally halogenated C2-C4 alkenyloxy group” include 2-propenyloxy and 3,3-dichloro-2-propenyloxy.

Examples of “an optionally halogenated C2-C4 alkynyloxy group” include 2-propinyloxy.

Next, the synthesis of the present compound will be illustrated.

The present compound can be produced by the following Synthetic Process 1 to Synthetic Process 4.

Synthetic Process 1

Among the present compounds, a compound represented by the formula (I-1):

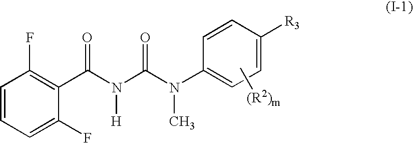

wherein R², R³, and m are as defined above, can be produced by the reaction of a compound represented by the formula (II):

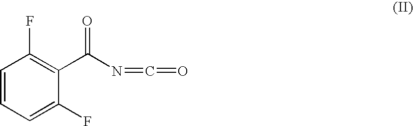

and a compound represented by the formula (III):

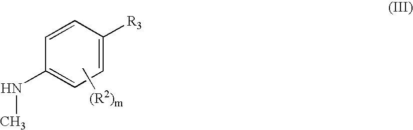

wherein R², R³, and m are as defined above.

Usually, the reaction is carried in a solvent.

Examples of the solvent to be used include ketones such as acetone and methyl ethyl ketone; aromatic hydrocarbons such as benzene, toluene, and xylene; aliphatic hydrocarbons such as hexane and heptane; ethers such as diethyl ether, tetrahydrofuran, 1,4-dioxane, 1,2-dimethoxyethane, and 1,2-diethoxyethane; halohydrocarbons such as chloroform, chlorobenzene, and dichlorobenzene; nitrites such as acetonitrile; non-protonic polar solvents such as N,N-dimethylformamide, N,N-dimethylacetamide, 1-methyl-2-pyrrolidone, 1,3-dimethylimidazolinone, dimethyl sulfoxide, and a mixture thereof.

The amount of the compound represented by the formula (III) is usually 0.5 to 2 moles relative to 1 mole of the compound represented by the formula (II).

Usually, the reaction temperature is in a range from −78 to 150° C. and the reaction time is in a range of 0.1 to 100 hours.

After completion of the reaction, the compound represented by the formula (I-1) can be isolated by post-treatment, for example, pouring the reaction mixture to water, extracting the mixture with an organic solvent, and drying and concentrating the resulting organic layer. The isolated compound represented by the formula (I-1) can be further purified by recrystallization, column chromatography, or the like.

Synthetic Process 2

The present compound represented by the formula (I-2):

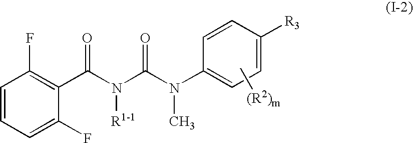

wherein R², R³, and m are as defined above; R¹⁻¹ denotes an optionally halogenated C1-C6 alkyl group, an optionally halogenated C2-C6 alkenyl group, a C2-C6 alkynyl group, a C6-C14 aryl group, a C7-C11 aralkyl group, a C2-C6 alkoxyalkyl group, a C7-C14 aryloxyalkyl group, a C3-C6 N,N-di(alkyl)aminoalkyl group, a C2-C6 alkylthioalkyl group, a C2-C6 alkylsulfinylalkyl group, a C2-C6 alkylsulfonylalkyl group, or a C3-C9 alkoxyalkyl group, can be produced by the reaction of a compound represented by the formula (IV):

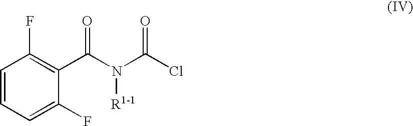

wherein X, Y, and R¹⁻¹ are as defined above: and a compound represented by the formula (III).

The reaction is usually carried out in a solvent in the presence of a base.

Examples of the solvent to be used include ketones such as acetone and methyl ethyl ketone; aromatic hydrocarbons such as benzene, toluene, and xylene; aliphatic hydrocarbons such as hexane and heptane; ethers such as diethyl ether, tetrahydrofuran, 1,4-dioxane, 1,2-dimethoxyethane, and 1,2-diethoxyethane; halohydrocarbons such as chloroform, chlorobenzene, and dichlorobenzene; nitrites such as acetonitrile; non-protonic polar solvents such as N,N-dimethylformamide, N,N-dimethylacetamide, 1-methyl-2-pyrrolidone, 1,3-dimethylimidazolinone, dimethyl sulfoxide, and a mixture thereof.

Examples of the base to be used include hydroxides of alkali metals and alkaline earth metals such as sodium hydroxide, potassium hydroxide, and calcium hydroxide; hydrides of alkali metals and alkaline earth metals such as sodium hydride, potassium hydride, and calcium hydride; carbonates of alkali metals and alkaline earth metals such as sodium carbonate and potassium carbonate; alkali metal alcoholates such as sodium ethylate and sodium methylate; organolithium compounds such as n-butyllithium and lithium diisopropylamide; and organic bases such as triethylamine, pyridine, 1,8-diazabicyclo[5,4,0]undecene (hereinafter, abbreviated as DBU).

In case that the reagents to be used are liquids under the reaction conditions, the amounts thereof can be such that they become solvents of respective reagents and, usually, the amount of the compound represented by the formula (III) is 1 to 4 mole and the amount of the base is 1 to 4 mole relative to 1 mole of the compound represented by the formula (IV).

Usually, the reaction temperature is in a range from −78 to 150° C. and the reaction time is in a range of 0.1 to 200 hours.

After completion of the reaction, the compound represented by the formula (I-2) can be isolated by post-treatment, for example, pouring the reaction mixture to water, extracting the mixture with an organic solvent, and drying and concentrating the resulting organic layer. The isolated compound represented by the formula (I-2) can be further purified by recrystallization, column chromatography, or the like.

Synthetic Process 3

The present compound represented by the formula (I-3):

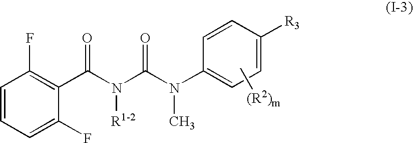

wherein R², R³, and m are as defined above; R¹⁻² denotes an optionally halogenated C1-6 alkyl group, an optionally halogenated C2-C6 alkenyl group, a C2-C6 alkynyl group, a C7-C11 aralkyl group, a C2-C6 alkoxyalkyl group, a C7-C14 aryloxyalkyl group, a C3-C6 dialkylaminoalkyl group, a C2-C6 alkylthioalkyl group, a C2-C6 alkylsulfinylalkyl group, a C2-C6 alkylsulfonylalkyl group, a C3-C9 alkoxyalkoxyalkyl group, a C2-C6 alkoxycarbonyl group, a C8-C12 aralkyloxycarbonyl group, a C3-C13 dialkylcarbamoyl group, an optionally halogenated C2-C6 alkylcarbonyl group, a formyl group, an optionally halogenated C1-C8 alkylsulfonyl group, and a C6-C10 arylsulfonyl group can be produced by the reaction of a compound represented by the formula (I-1) and a compound represented by the formula (V):

L¹-R¹⁻² (V)

wherein R¹⁻² is as defined above; L¹ denotes a halogen atom (e.g., a chlorine atom and a bromine atom); methanesulfonyloxy, benzenesulfonyloxy, toluenesulfonyloxy, methoxysulfonyloxy, or ethoxysulfonyloxy: in the presence of a base.

The reaction is usually carried out in a solvent in the presence of a base.

Examples of the solvent to be used include ketones such as acetone and methyl ethyl ketone; aromatic hydrocarbons such as benzene, toluene, and xylene; aliphatic hydrocarbons such as hexane and heptane; ethers such as diethyl ether, tetrahydrofuran, 1,4-dioxane, 1,2-dimethoxyethane, and 1,2-diethoxyethane; halohydrocarbons such as chloroform, chlorobenzene, and dichlorobenzene; nitrites such as acetonitrile; non-protonic polar solvents such as N,N-dimethylformamide, N,N-dimethylacetamide, 1-methyl-2-pyrrolidone, 1,3-dimethylimidazolinone, dimethyl sulfoxide, and a mixture thereof.

Examples of the base to be used include hydroxides of alkali metals and alkaline earth metals such as sodium hydroxide, potassium hydroxide, and calcium hydroxide; hydrides of alkali metals and alkaline earth metals such as sodium hydride, potassium hydride, and calcium hydride; carbonates of alkali metals and alkaline earth metals such as sodium carbonate and potassium carbonate; alkali metal alcoholates such as sodium ethylate and sodium methylate; organolithium compounds such as n-butyllithium and lithium diisopropylamide; and organic bases such as triethylamine, pyridine, and DBU.

In case that the reagents to be used are liquids under the reaction conditions, the amounts thereof can be such that they become solvents of respective reagents and, usually, the amount of the compound represented by the formula (V) is 1 to 4 mole and the amount of the base is 1 to 4 mole relative to 1 mole of the compound represented by the formula (I-1).

Usually, the reaction temperature is in a range from to 150° C. and the reaction time is in a range of 0.1 to 100 hours.

After completion of the reaction, the compound represented by the formula (I-3) can be isolated by post-treatment, for example, pouring the reaction mixture to water, extracting the mixture with an organic solvent, and drying and concentrating the resulting organic layer. The isolated compound represented by the formula (I-3) can be further purified by recrystallization, column chromatography, or the like.

Synthetic Process 4

The present compound represented by the formula (I-2):

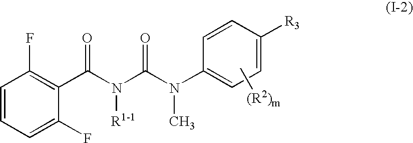

wherein R², R³, R¹⁻¹, and m are as defined above can be produced by the reaction of a compound represented by the formula (VI):

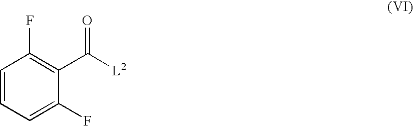

wherein L² denotes a halogen atom (e.g., a chlorine atom, a bromine atom, and an iodine atom) and a compound represented by the formula (VII):

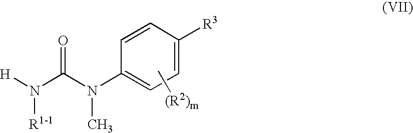

wherein R¹, R², R³, and m are as defined above.

The reaction is usually carried out in a solvent in the presence of a base.

Examples of the solvent to be used include ketones such as acetone and methyl ethyl ketone; aromatic hydrocarbons such as benzene, toluene, and xylene; aliphatic hydrocarbons such as hexane and heptane; ethers such as diethyl ether, tetrahydrofuran, 1,4-dioxane, 1,2-dimethoxyethane, and 1,2-diethoxyethane; halohydrocarbons such as chloroform, chlorobenzene, and dichlorobenzene; nitrites such as acetonitrile; non-protonic polar solvents such as N,N-dimethylformamide, N,N-dimethylacetamide, 1-methyl-2-pyrrolidone, 1,3-dimethylimidazolinone, dimethyl sulfoxide, and a mixture thereof.

Examples of the base to be used include hydroxides of alkali metals and alkaline earth metals such as sodium hydroxide, potassium hydroxide, and calcium hydroxide; hydrides of alkali metals and alkaline earth metals such as sodium hydride, potassium hydride, and calcium hydride; carbonates of alkali metals and alkaline earth metals such as sodium carbonate and potassium carbonate; alkali metal alcoholates such as sodium ethylate and sodium methylate; organolithium compounds such as n-butyllithium and lithium diisopropylamide; and organic bases such as triethylamine, pyridine, and DBU.

In case that the reagents to be used are liquids under the reaction conditions, the amounts thereof can be such that they become solvents of respective reagents and, usually, the amount of the compound represented by the formula (VI) is 1 to 4 mole and the amount of the base is 1 to 4 mole relative to 1 mole of the compound represented by the formula (VII).

Usually, the reaction temperature is in a range from −78 to 180° C. and the reaction time is in a range of 0.1 to 200 hours.

After completion of the reaction, the compound represented by the formula (I-2) can be isolated by post-treatment, for example, pouring the reaction mixture to water, extracting the mixture with an organic solvent, and drying and concentrating the resulting organic layer. The isolated compound represented by the formula (I-2) can be further purified by recrystallization, column chromatography, or the like.

Next, reference production processes of the intermediates of the present compound will be illustrated.

Reference Production Process 1

The compound represented by the formula (IV) can be produced by the reaction of a compound represented by the formula (VIII):

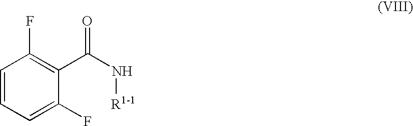

wherein R¹⁻¹ is as defined above, and a trialkylchlorosilane compound and a chlorocarbonylation agent.

The reaction is usually carried out in a solvent in the presence of a base.

Examples of the solvent to be used include ketones such as acetone and methyl ethyl ketone; aromatic hydrocarbons such as benzene, toluene, and xylene; aliphatic hydrocarbons such as hexane and heptane; ethers such as diethyl ether, tetrahydrofuran, 1,4-dioxane, 1,2-dimethoxyethane, and 1,2-diethoxyethane; halohydrocarbons such as chloroform, chlorobenzene, and dichlorobenzene; nitrites such as acetonitrile; non-protonic polar solvents such as N,N-dimethylformamide, N,N-dimethylacetamide, 1-methyl-2-pyrrolidone, 1,3-dimethylimidazolinone, dimethyl sulfoxide, and a mixture thereof.

Examples of the base to be used include hydroxides of alkali metals and alkaline earth metals such as sodium hydroxide, potassium hydroxide, and calcium hydroxide; hydrides of alkali metals and alkaline earth metals such as sodium hydride, potassium hydride, and calcium hydride; carbonates of alkali metals and alkaline earth metals such as sodium carbonate and potassium carbonate; alkali metal alcoholates such as sodium ethylate and sodium methylate; organolithium compounds such as n-butyllithium and lithium diisopropylamide; and organic bases such as triethylamine, pyridine, and DBU.

Examples of the trialkylchlorosilane compound include trimethylchlorosilane and trimethylchlorosilane.

Examples of the chlorocarbonylation agent to be used include be phosgene, trichloromethyl chloroformate, bis(trichloromethyl) carbonate, or the like.

Regarding the amounts of reagents, the amount of the trialkylchlorosilane compound is 1 to 4 moles and the amount of the base is 1 to 4 moles relative to 1 mole of the compound represented by the formula (VIII).

Usually, the reaction temperature is in a range from −78 to 150° C. and the reaction time is in a range of 0.1 to 200 hours.

After completion of the reaction, the compound represented by the formula (IV) can be isolated by post-treatment, for example, concentrating the reaction mixture as it is. The isolated compound represented by the formula (IV) can be used for the next step without purification.

Reference Production Process 2

The compound represented by the formula (VII) can be produced by the reaction of a compound represented by the general formula (IX):

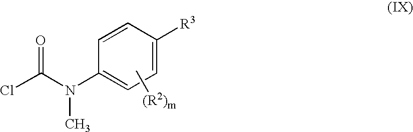

wherein R², R³; and m are as defined above, and a compound represented by the formula (X):

H₂N—R¹⁻¹ (X)

wherein R¹⁻¹ is as defined above.

The reaction is usually carried out in a solvent in the presence of a base.

Examples of the solvent to be used include ketones such as acetone and methyl ethyl ketone; aromatic hydrocarbons such as benzene, toluene, and xylene; aliphatic hydrocarbons such as hexane and heptane; ethers such as diethyl ether, tetrahydrofuran, 1,4-dioxane, 1,2-dimethoxyethane, and 1,2-diethoxyethane; halohydrocarbons such as chloroform, chlorobenzene, and dichlorobenzene; nitrites such as acetonitrile; non-protonic polar solvents such as N,N-dimethylformamide, N,N-dimethylacetamide, 1-methyl-2-pyrrolidone, 1,3-dimethylimidazolinone, dimethyl sulfoxide, and a mixture thereof.

Examples of the base to be used include hydroxides of alkali metals and alkaline earth metals such as sodium hydroxide, potassium hydroxide, and calcium hydroxide; hydrides of alkali metals and alkaline earth metals such as sodium hydride, potassium hydride, and calcium hydride; carbonates of alkali metals and alkaline earth metals such as sodium carbonate and potassium carbonate; alkali metal alcoholates such as sodium ethylate and sodium methylate; organolithium compounds such as n-butyllithium and lithium diisopropylamide; and organic bases such as triethylamine, pyridine, and DBU. Alternatively, an excess amount of (X) can also be used as the base.

Regarding the amounts of reagents to be used, the amount of the compound represented by the formula (X) is 1 to 6 moles and the amount of the base is 1 to 6 moles relative to 1 mole of the compound represented by the formula (IX).

Usually, the reaction temperature is in a range from −78 to 150° C. and the reaction time is in a range of 0.1 to 200 hours.

After completion of the reaction, the compound represented by the formula (VII) can be isolated by post-treatment, for example, pouring the reaction mixture to water, extracting the mixture with an organic solvent, and drying and concentrating the resulting organic layer. The isolated compound represented by the formula (VII) can be further purified by recrystallization, column chromatography, or the like.

Reference Production Process 3

The compound represented by the formula (IX) can be produced by the reaction of the compound represented by the formula (III) and a chlorocarbonylation agent.

The reaction is usually carried out in a solvent in the presence of a base.

Examples of the solvent to be used include ketones such as acetone and methyl ethyl ketone; aromatic hydrocarbons such as benzene, toluene, and xylene; aliphatic hydrocarbons such as hexane and heptane; ethers such as diethyl ether, tetrahydrofuran, 1,4-dioxane, 1,2-dimethoxyethane, and 1,2-diethoxyethane; halohydrocarbons such as chloroform, chlorobenzene, and dichlorobenzene; nitriles such as acetonitrile; non-protonic polar solvents such as N,N-dimethylformamide, N,N-dimethylacetamide, 1-methyl-2-pyrrolidone, 1,3-dimethylimidazolinone, dimethyl sulfoxide, and a mixture thereof.

Examples of the base to be used include hydroxides of alkali metals and alkaline earth metals such as sodium hydroxide, potassium hydroxide, and calcium hydroxide; hydrides of alkali metals and alkaline earth metals such as sodium hydride, potassium hydride, and calcium hydride; carbonates of alkali metals and alkaline earth metals such as sodium carbonate and potassium carbonate; alkali metal alcoholates such as sodium ethylate and sodium methylate; organolithium compounds such as n-butyllithium and lithium diisopropylamide; and organic bases such as triethylamine, pyridine, and DBU.

Examples of the chlorocarbonylation agent to be used include phosgene, trichloromethyl chloroformate, bis(trichloromethyl) carbonate, or the like.

Regarding the amounts of reagents to be used, the amount of the chlorocarbonylation agent is 1 to 4 moles and the amount of the base is 1 to 4 moles relative to 1 mole of the compound represented by the formula (III).

Usually, the reaction temperature is in a range from −78 to 150° C. and the reaction time is in a range of 0.1 to 200 hours.

After completion of the reaction, the compound represented by the formula (IX) can be isolated by post-treatment, for example, pouring the reaction mixture to water, extracting the mixture with an organic solvent, and drying and concentrating the resulting organic layer. The isolated compound represented by the formula (IX) can be further purified by column chromatography or the like. Alternatively, after completion of the reaction, the compound represented by the formula (IX) can be isolated by post-treatment, for example, concentrating the reaction mixture as it is.

The compounds produced by the above-mentioned synthetic processes can be further subjected to alkylation, alkenylation, alkynylation, acylation, amination, sulfidation, sulfinylation, sulfonation, oxidation, reduction, halogenation, and nitration to replace substituents with other desired substituents.

Specific examples of the present compound are as follows.

(N′-methyl)benzoylurea compounds in which R¹ denotes a hydrogen atom, an optionally halogenated C1-C6 alkyl group, an optionally halogenated C2-C6 alkenyl group, a C2-C6 alkynyl group, a C6-C14 aryl group, a C7-C11 aralkyl group, or a C2-C6 alkoxyalkyl group;
(N′-methyl)benzoylurea compounds in which R¹ denotes a hydrogen atom, an optionally halogenated C1-C6 alkyl group, or a C2-C6 alkoxyalkyl group;
(N′-methyl)benzoylurea compounds in which R¹ denotes a hydrogen atom, a methyl group, or a methoxymethyl group;
(N′-methyl)benzoylurea compounds in which m denotes 0 or 1;
(N′-methyl)benzoylurea compounds in which R² denotes a halogen atom and m denotes 0 or 1;
(N′-methyl)benzoylurea compounds in which R³ denotes a halogen atom, an optionally halogenated C1-C4 alkoxy group, or an optionally halogenated C1-C4 alkyl group;
(N′-methyl)benzoylurea compounds in which R³ denotes a halogen atom group, a trifluoromethoxy group, a 1,1,2,2-tetrafluoroethoxy group, or a trifluoromethyl group; (N′-methyl)benzoylurea compounds in which R¹ denotes a hydrogen atom, an optionally halogenated C1-C6 alkyl group, an optionally halogenated C2-C6 alkenyl group, a C2-C6 alkynyl group, a C6-C14 aryl group, a C7-C11 aralkyl group, or a C2-C6 alkoxyalkyl group; R² denotes a halogen atom; R³ denotes a halogen atom, an optionally halogenated C1-C4 alkoxy group, or an optionally halogenated C1-C4 alkyl group; and
(N′-methyl)benzoylurea compounds in which R¹ denotes a hydrogen atom, a C1-C6 alkyl group, or a C2-C6 alkoxyalkyl group; R² denotes a halogen atom; R³ denotes a halogen atom, a trifluoromethoxy group, a 1,1,2,2-tetrafluoroethoxy group, or a trifluoromethyl group.

In the method for producing treated seeds of the present invention (hereinafter, referred to as the present production method and the present plant seeds, respectively), the seeds can be treated with the present compound as it is. However, in general, the seeds are treated with a composition comprising the present compound. As such a composition, usually, the present compound can be used in the form of a preparation obtained by mixing the present compound or a salt thereof with a carrier such as a solid or liquid carrier and if necessary, a surfactant, a suspension agent, a developer, a penetrating agent, a moistening agent, a thickening agent, a stabilizer, or the like, or a water-diluted solution of the preparation. Examples of the composition include liquid preparations such as emulsions, solutions, micro-emulsions, flowable preparations, and oil-based preparations; solid preparations such as hydrated preparations, water-soluble preparations, sol preparations, powder preparations, pellets, tables, and film preparations; and capsulated preparations obtained by encapsulating or over-coating preparations containing the present compound.

Examples of the solid carrier to be used for the above-mentioned preparations include vegetable powders (soybean powder, tobacco powder, wheat flour, wood flour, etc.); mineral powders (clays such as kaolin, bentonite, and acidic white clay; talc such as talc powder and agalmatolite; and silica such as diatomaceous earth and mica powder); alumina, sulfur powder, activated carbon, calcium carbonate, ammonium sulfate, sodium hydrogen carbonate, lactose, and urea. When using these solid carriers for the plant protecting composition of the present invention, one or more of these solid carriers can be used at an appropriate mixing ratio. Examples of the liquid carrier include alcohols (methyl alcohol, ethyl alcohol, n-propyl alcohol, isopropyl alcohol, and ethylene glycol), ketones (acetone, methyl ethyl ketone, methyl isobutyl ketone, and cyclohexanone), ethers (tetrahydrofuran, ethylene glycol monomethyl ether, diethylene glycol monomethyl ether, and propylene glycol monomethyl ether), aliphatic hydrocarbons (kerosene, fuel oil, and machine oil), aromatic hydrocarbons (toluene, xylene, solvent naphtha, and methylnaphthalene), halo hydrocarbons (dichloromethane, chloroform, and tetrachloromethane), acid amides (N,N-dimethylformamide, N,N-dimethylacetamide, and N-methylpyrrolidone), esters (ethyl acetate, butyl acetate, fatty acid glycerin esters, γ-butyrolactone), and nitriles (acetonitrile and propionitrile). When a liquid carrier is used for a plant protecting composition of the present invention, one or more of these liquid carriers can be at an appropriate mixing ratio.

Further, examples of the surfactant to be used at need include soaps and nonionic and anionic surfactants such as polyoxyethylene alkyl ethers [e.g. Noigen (trade name) and EA 142 (trade name), manufactured by Dai-Ichi Kogyo Seiyaku Co., Ltd. and Nonal (trade name), manufactured by Kao Corporation]; alkyl sulfates [e.g. Emal 10 (trade name) and Emal 40 (trade name) manufactured by Kao Corporation]; alkylbenzenesulfonic acid salts [e.g. Neogen (trade name) and Neogen T (trade name), manufactured by Dai-Ichi Kogyo Seiyaku Co., Ltd., and Nepelex (trade name), manufactured by Kao Corporation]; polyethylene glycol ethers [e.g. Nonipol 85 (trade name), Nonipol 100 (trade name), and Nonipol 160 (trade name), manufactured by Sanyo Chemical Industries, Ltd.]; polyhydric alcohol esters [e.g. Tween 20 (trade name), and Tween 80 (trade name), manufactured by Kao Corporation]; alkylsulfosuccinates [e.g. Sanmorin OT 20 (trade name), manufactured by Sanyo Chemical Industries, Ltd., and Newkalgen EX 70 (trade name), manufactured by Takemoto Oil and Fat Co., Ltd.]; alkylnaphthalenesulfonates, and alkenylsulfonates [e.g. Sorpol 5115 (trade name), manufactured by Toho Chemical Industry Co., Ltd.].

Examples of the treating method of plant seeds with the composition comprising the present compound include conventional known seed treatment methods such as impregnation and adhesion.

In the present invention, the impregnation includes such a method that plant seeds are immersed or soaked in a liquid composition containing as main components water and the present compound (dissolved or dispersed) to impregnate the plant seeds with the present compound.

The liquid composition to be used for the impregnation can contain an additional solvent, which is sometimes useful for increasing the solubility of the present compound and the penetrability in the plant seeds, such as methanol, ethanol, isopropanol, ethylene glycol, propylene glycol, propylene carbonate, benzyl alcohol, dibasic acid esters, acetone, methyl acetate, ethyl acetate, cyclohexanone, dimethyl sulfoxide, N-methylpyrrolidone and a mixture thereof as far as that the solvent cause no adverse effect on a plant. Further, when a surfactant is used, it makes easy to wet plant seeds and impregnate the seeds with the present compound. Preferably, a water-diluted solution of the above-mentioned emulsion preparations, micro-emulsion preparations, hydrated preparations, water-soluble preparations and sol preparations are used as the liquid composition. The concentration of the present compound in the liquid composition is usually about 0.01 ppm to 100,000 ppm and preferably 1 ppm to 1000 ppm.

In the present invention, the adhesion treatment can be carried out by spraying a liquid composition containing the present compound to the surfaces of plant seeds and then drying the seeds; sticking a powder-like material containing the present compound to the surfaces of plant seeds using a fixing agent (e.g. methyl cellulose and gum arabic); mixing the present compound and a binder (e.g. synthetic polymers such as polyvinyl alcohol, hydrolyzed polyvinyl acetate, polyvinyl methyl ether, polyvinyl methyl ether-maleic anhydride copolymer, and polyvinyl pyrrolidinone, alginates, Karaya gum, Guar gum, tragacanth gum, and polysaccharide gum) and a solid carrier (e.g. wood flour, clay, activated carbon, diatomaceous earth, finely divided inorganic solid, and calcium carbonate), molding the mixture into pellet-like shape, and drying; and wrapping plant seeds with a film-forming material (e.g. polymers and copolymers of vinyl acetate, polyvinyl pyrrolidine-vinyl acetate copolymers, and water-soluble waxes) containing the present compound.

The thickness of a layer of the composition containing the present compound formed on the surfaces of plant seeds is in a range from that of a thin film to that of a pellet layer, that is, in a range from about 0.1 to 10 mm. The amount of the present compound to be stuck to the surfaces of plant seeds is usually in a range of about 0.0001% to 500%, preferably in arrange of 0.001% to 200% to relative the weight of the present plant seeds.

In the adhesion treatment, sometimes, it is advantageous to add a solvent such as methanol, ethanol, methyl acetate, ethyl acetate, acetone, and cyclohexanone to the layer of the composition containing the present compound which is stuck to the surfaces of plant seeds to improve the solubility and adhesion property of the present compound as far as the solvent has no adverse affect on a plant. Further, a surfactant can be added to make plant seeds easy to be wet.

The seed treatment composition of the present invention can further contain other active components in addition to the present compound. Examples of the additional active ingredient include insecticides (e.g. pyrethroid insecticides, organophosphate insecticides, carbamate insecticides, neonicotinoid insecticides, natural insecticides), acaricides, machine oils, nematicides, herbicides, plant hormones, plant growth regulating substances, fungicides (e.g. copper fungicides, organic chlorine fungicides, organic sulfur fungicides, phenol fungicides), synergists, attractants, repellants, agents for alleviating chemical injuries, colorants, fertilizers and the like.

Examples of the insecticide include

(1) Organophosphate insecticides;

aluminum phosphide, butathiofos, cadusafos, chlorethoxyfos, chlorfenvinphos, chlorpyrifos, chlorpyrifos-methyl, cyanophos (CYAP), diazinon, DCIP (dichlorodiisopropyl ether), dichlofenthion (ECP), dichlorvos (DDVP), dimethoate, dimethylvinphos, disulfoton, EPN, ethion, ethoprophos, etrimfos, fenthion (MPP), fenitrothion (MEP), fosthiazate, formothion, hydrogen phosphide, isofenphos, isoxathion, malathion, mesulfenfos, methidathion (DMTP), monocrotophos, naled (BRP), oxydeprofos (ESP), parathion, phorate, phosalone, phosmet (PMP), pirimiphos-methyl, pyridafenthion, quinalphos, phenthoate (PAP), profenofos, propaphos, prothiofos, pyraclorfos, salithion, sulprofos, tebupirimfos, temephos, tetrachlorvinphos, terbufos, thiometon, trichlorphon (DEP), vamidothion, and the like;

(2) carbamate insecticides:

alanycarb, aldicarb, bendiocarb, benfuracarb, BPMC, carbaryl, carbofuran, carbosulfan, cloethocarb, ethiofencarb, fenobucarb, fenothiocarb, fenoxycarb, furathiocarb, isoprocarb (MIPC), metolcarb, methomyl, methiocarb, NAC, oxamyl, pirimicarb, propoxur (PHC), XMC, thiodicarb, xylylcarb, and the like;

(3) synthetic pyrethroid insecticides:

acrinathrin, allethrin, benfluthrin, beta-cyfluthrin, bifenthrin, cycloprothrin, cyfluthrin, cyhalothrin, cypermethrin, deltamethrin, esfenvalerate, ethofenprox, fenpropathrin, fenvalerate, flucythrinate, flufenoprox, flumethrin, fluvalinate, halfenprox, imiprothrin, permethrin, prallethrin, pyrethrins, resmethrin, sigma-cypermethrin, silafluofen, tefluthrin, tralomethrin, transfluthrin, 2,3,5,6-tetrafluoro-4-(methoxymethyl)benzyl (EZ)-(1RS,3RS;1RS,3SR)-2,2-dimethyl-3-prop-1-enylcyclopropanecarboxylate, 2,3,5,6-tetrafluoro-4-methylbenzyl (EZ)-(1RS,3RS;1RS,3SR)-2,2-dimethyl-3-prop-1-enylcyclopropanecarboxylate, 2,3,5,6-tetrafluoro-4-(methoxymethyl)benzyl (1RS,3RS;1RS,3SR)-2,2-dimethyl-3-(2-methyl-1-propenyl)cyclopropanecarboxylate, and the like;

(4) nereistoxin compounds:

cartap, bensultap, thiocyclam, monosultap, bisultap, and the like;

(5) neonicotinoid compounds:

imidacloprid, nitenpyram, acetamiprid, thiamethoxam, thiacloprid, and the like;

(6) benzoylurea compounds:

chlorfluazuron, bistrifluoron, diafenthiuron, diflubenzuron, fluazuron, flucycloxuron, flufenoxuron, hexaflumuron, lufenuron, novaluron, noviflumuron, teflubenzuron, triazuron, triflumuron, and the like;

(7) phenylpyrazole compounds:

acetoprole, fipronil, vaniliprole, pyriprole, pyrafluprole, and the like;

(8) Bt toxin insecticides:

live spores derived from and crystal toxins produced from Bacillus thuringiesis and a mixture thereof;

(9) hydrazine compounds:

chromafenozide, halofenozide, methoxyfenozide, tebufenozide, and the like;

(10) organic chlorine compounds:

aldrin, dieldrin, dienochlor, endosulfan, methoxychlor, and the like;

(11) natural insecticides:

machine oil, nicotine sulfate, and the like;

(12) other insecticides:

avermectin-B, cyenopyrafen, bromopropylate, buprofezin, chlorphenapyr, cyenopyrafen, cyromazine, D-D (1,3-dichloropropene), emamectin-benzoate, fenazaquin, flupyrazofos, hydroprene, indoxacarb, lepimectin, metoxadiazone, milbemycin-A, pymetrozine, pyridalyl, pyriproxyfen, spinosad, sulfluramid, tolfenpyrad, triazamate, flubendiamide, cyflumetofen, arsenic acid, benclothiaz, calcium cyanamide, calcium polysulfide, chlordane, DDT, DSP, flufenerim, flonicamid, flurimfen, formetanate, metam-ammonium, metam-sodium, methyl bromide, nidinotefuran, potassium oleate, protrifenbute, spiromesifen, sulfur, metaflumizone, spirotetramat, pyrifluquinazon, tralopyril, a compound represented by the following formula (A):

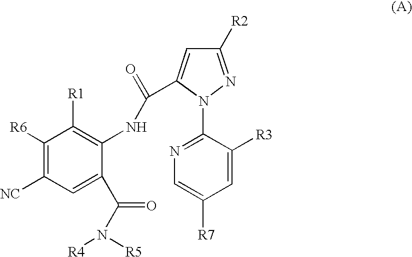

wherein R¹ represents Me, Cl, Br or F, R² represents F, Cl, Br, C1-C4 haloalkyl or C1-C4 haloalkoxy, R³ represents F, Cl or Br, R⁴ represents H, or C1-C4 alkyl, C3-C4 alkenyl, C3-C4 alkynyl, C3-C5 cycloalkyl or C4-C6 cycloalkylalkyl which may be substituted with one or more substituents selected from the group consisting of a halogen atom, CN, SMe, S(O)Me, S(O)₂Me and OMe, R⁵ represents H or Me, R⁶ represents H, F or Cl, and R⁷ represents H, F or Cl; and the like.

Examples of the acaricide include acequinocyl, amitraz, benzoximate, bifenazate, bromopropylate, chinomethionat, chlorobenzilate, CPCBS (chlorfenson), clofentezine, cyenopyrafen, cyflumetofen, kelthane (dicofol), etoxazole, fenbutatin oxide, fenothiocarb, fenpyroximate, fluacrypyrim, fluproxyfen, hexythiazox, propargite (BPPS), polynactins, pyridaben, pyrimidifen, tebufenpyrad, tetradifon, spirodiclofen, spiromesifen, spirotetramat, amidoflumet, and the like.

Examples of the nematicide include DCIP, fosthiazate, levamisol hydrochloride, methylisothiocyanate, morantel tartarate, imicyafos, and the like.

Examples of the fungicides include acibenzolar-S-methyl, amobam, amisulbrom, ampropylfos, anilazine, azoxystrobin, benalaxyl, benodanil, benomyl, benthiavalicarb, benthiazole, benthoxazin, bitertanol, blasticidin-S, Bordeaux mixture, boscalid, bromuconazole, buthiobate, calcium hypochlorite, calcium polysulfide, captan, carbendazol, carboxin, carpropamid, chlobenthiazone, chloroneb, chloropicrin, chlorothalonil (TPN), chlorthiophos, cinnamaldehyde, clozylacon, CNA (2,6-dichloro-4-nitroaniline), copper hydroxide, copper sulfate, cyazofamid, cyfluphenamid, cymoxanil, cyproconazole, cyprodinil, cyprofuram, dazomet, debacarb, dichlofluanid, D-D (1,3-dichloropropene), diclocymet, diclomezine, diethofencarb, difenoconazole, diflumetorim, dimefluazole, dimethirimol, dimethomorph, diniconazole-M, dinocap, edifenphos, enestroburin, epoxiconazole, nickel dimethyldithiocarbamate, etaconazole, ethaboxam, ethirimol, etridiazole, famoxadone, fenamidone, fenarimol, fenbuconazole, fendazosulam, fenhexamid, fenoxanil, fenpiclonil, fenpropidin, fenpropimorph, fentiazon, fentin hydroxide, ferimzone, fluazinam, fludioxonil, flumetover, flumorph, fluoroimide, fluotrimazole, fluoxastrobin, fluquinconazole, flusilazole, flusulfamide, flutolanil, flutriafol, fosetyl-Al, fthalide, fuberidazole, furalaxyl, furametpyr, furcarbanil, furconazole-cis, hexaconazole, hymexazol, IBP, imazalil, imibenconazole, iminoctadine-albesilate, iminoctadine-triacetate, iodocarb, ipconazole, iprodione, iprovalicarb, isoprothiolane, kasugamycin, kresoxim-methyl, mancozeb, mandipropamid, maneb, mepanipyrim, mepronil, meptyldinocap, metalaxyl, metalaxyl-M, metam-sodium, methasulfocarb, methyl bromide, metconazole, methfuroxam, metominostrobin, metrafenone, metsulfovax, mildiomycin, milneb, myclobutanil, myclozolin, nabam, orysastrobin, ofurace, oxadixyl, oxolinic acid, oxpoconazole, oxycarboxin, oxytetracycline, pefurazoate, penconazole, pencycuron, picoxystrobin, polycarbamate, polyoxin, potassium hydrogen carbonate, probenazole, prochloraz, procymidone, propamocarb-hydrochloride, propiconazole, propineb, proquinazid, prothiocarb, prothioconazole, pyracarbolid, pyraclostrobin, pyrazophos, pyributicarb, pyrifenox, pyrimethanil, pyroquilon, quinoxyfen, quintozene (PCNB), silthiopham, simeconazole, sipconazole, sodium bicarbonate, sodium hypochlorite, spiroxamine, SSF-129 ((E)-2-[2-(2,5-dimethylphenoxymethyl)phenyl]-2-methoxyimino-N-methylacetamide), streptomycin, sulfur, tebuconazole, tecloftalam, tetraconazole, thiabendazole, thiadinil, thiram (TMTD), thifluzamide, thiophanate-methyl, tolclofos-methyl, TPN, triadimefon, triadimenol, triazoxide, triclamide, tricyclazole, tridemorph, triflumizole, trifloxystrobin, triforine, triticonazole, validamycin, vinclozolin, viniconazole, zineb, ziram, zoxamide, and the like.

Examples of the herbicide and/or the plant growth regulating substance include abscisic acid, acetochlor, acidluorfen-sodium, alachlor, alloxydim, ametryn, amicarbazone, amidosulfuron, aminoethoxyvinylglycine, aminopyralid, AC94, 377, amiprofos-methyl, ancymidol, asulam, atrazine, aviglycine, azimsulfuron, beflubutamid, benfluralin, benfuresate, bensulfuron-methyl, bensulide (SAP), bentazone, benthiocarb, benzamizole, benzfendizone, benzobicyclon, benzofenap, benzyl adenine, benzylaminopurine, bialaphos, bifenox, brassinolide, bromacil, bromobutide, butachlor, butafenacil, butamifos, butylate, canfestrole, calcium carbonate, calcium peroxide, carbaryl, chlomethoxynil, chloridazon, chlorimuron-ethyl, chlorphthalim, chlorpropham, chlorsulfuron, chlorthal-dimethyl, chlorthiamid (DCBN), choline chloride, cinidon-ethyl, cinmethylin, cinosulfuron, clethodim, clomeprop, cloxyfonac-sodium, chlormequat chloride, 4-CPA (4-chlorophenoxyacetic acid), cliprop, clofencet, cumyluron, cyanazine, cyclanilide, cyclosulfamron, cyhalofop-butyl, 2,4-D salt (2,4-dichlorophenoxyacetic acid salts), dichlorprop (2,4-DP), daimuron, dalapon (DPA), dimethenamid-P, daminozide, dazomet, n-decyl alcohol, dicamba-sodium (MDBA), dichlobenil (DBN), diflufenican, dikegulac, dimepiperate, dimethametryn, dimethenamid, diquat, dithiopyr, diuron, endothal, epocholeone, esprocarb, ethephon, ethidimuron, ethoxysulfuron, ethychlozate, etobenzanid, fenarimol, fenoxaprop-ethyl, fentrazamide, flazasulfuron, florasulam, fluazifop-butyl, fluazolate, flucarbazone, flucetosulfuron, flufenacet, flufenpyr, flumetralin, flumioxazin, flupropanate-sodium, flupyrsulfuron-methyl-sodium, flurprimidol, fluthiacet-methyl, foramsulfuron, forchlorfenuron, formesafen, gibberelin, glufosinate, glyphosate, halosulfuron-methyl, hexazinone, imazamox, imazapic, imazapyr, imazaquin, imazosulfuron, inabenfide, indole acetic acid (IAA), indole butyric acid, iodosulfuron, ioxynil-octanoate, isouron, isoxachlortole, isoxadifen, karbutilate, lactofen, lenacil, linuron, LGC-42153, maleic hydrazide, mecoprop (MCPP), MCP salts (2-methyl-4-chlorophenoxyacetic acid salts), MCPA-thioethyl, MCPB (2-methyl-4-chlorophenoxybutanoic acid ethyl ester), mefenacet, mefluidide, mepiquat, mesosulfuron, mesotrione, methyl daimuron, metolachlor, metribuzin, metsulfuron-methyl, molinate, naphthylacetic acid, NAD (1-naphthaleneacetamide), naproanilide, napropamide, n-decyl alcohol, nicosulfuron, n-phenylphthalamic acid, orbencarb, orthosulfanuron, oxadiazon, oxaziclomefone, oxine-sulfate, paclobutrazol, paraquat, pelargonic acid, pendimethalin, pentoxazone, pethoxamide, phenmedipham, picloram, picolinafen, pinoxaden, piperonyl butoxide, piperophos, pretilachlor, primisulfuron-methyl, procarbazone, prodiamine, profluazol, profoxydim, prohexadione-calcium, prohydrojasmon, prometryn, propanil, propoxycarbazone, propyrzamide, pyraflufen-ethyl, pyrasulfotole, pyrazolate, pyrazosulfuron-ethyl, pyrazoxyfen, pyribenzoxim, pyributicarb, pyridafol, pyridate, pyriftalid, pyriminobac-methyl, pyrithiobac, quiclorac, quinoclamine, quizalofop-ethyl, rimsulfuron, sethoxydim, siduron, simazine, simetryn, sodium chlorate, sulfosufuron, swep (MCC), tebuthiuron, tefurytrione, tembotrione, tepraloxydim, terbacil, terbucarb (MBPMC), thenylchlor, thiazafluoron, thidiazuron, thiencarbazone methyl, thifensulfuron-methyl, triaziflam, tribufos, triclopyr, tridiphane, trifloxysulfuron, trifluralin, trinexapac-ethyl, tritosulfuron, uniconazole-P, vemolate (PPTC), flucetosulfuron, orthosulfanuron, pinoxaden, pyrasulfotole, tefuryltrione, tembotrione, thiencarbazone methyl, and the like.

Examples of the synergists include: piperonyl butoxide, sesamex, sulfoxide, MGK 264, WARF-antiresistant, and diethyl maleate, and examples of active components of a safener include benoxacor, cloquintocet-mexyl, cyometrinil, daimuron, dichlormid, fenchlorazole-ethyl, fenclorim, flurazole, fluxofenim, furilazole, mefenpyr-diethyl, MG191, naphthalic anhydride, and oxabetrinil.

The method for preventing damage by insect pests which cause damages on plants after germination in the present invention can be carried out by sowing treated seeds obtained by the production method of the present invention in soil such as well-drained paddy fields, rice paddies, dry fields, etc.; nursery soil for planting nursery plants; mats for nursery plants; and hydroponics solutions and planting the plants in normal conditions.

Examples of the plant seeds to which the composition for seed treatment of the present invention can be applied include seeds of plants selected from the group consisting of vegetables, corn, cotton, rice, sugar beet and soybean.

More specifically, examples of the vegetables include Solanaceae vegetables (eggplant, tomato, green pepper, red pepper, potato, etc.); Cucurbitaceae vegetables (cucumber, squash, zucchini, water melon, melon, etc.); Cruciferae vegetables (Japanese radish, turnip, horseradish, kohlrabi, Chinese cabbage, cabbage, brown mustard, broccoli, cauliflower, canola, etc.); Compositae vegetables (cocklebur, garland chrysanthemum, artichoke, lettuce, etc.); Liliaceae vegetables (Welsh onion, onion, garlic, asparagus, etc.); Umbelliferae vegetables (carrot, parsley, celery, parsnip, etc.); Chenopodiaceae vegetables (spinach, chard, etc.); labiatae vegetables (beefsteak plant, mint, basil, etc.); strawberry, sweet potato, Japanese yam, aroid, and so forth.

Further, in case that a plant can differentiate or propagate via reproduced bodies such as root stalks, stem tubers, discoid stems, solid bulbs, etc., the composition for seed treatment of the present invention can prevent plants from harms of harmful insects after differentiation or propagation by treating the reproduced bodies with the composition for seed treatment

The plant seeds also include seeds of crops provided with resistance to herbicides by traditional breeding methods and genetic engineering techniques. No problem caused by herbicides occurs for the crops provided with resistance to herbicides even when applying herbicides, for example, HPPD inhibitors such as isoxaflutole; ALS inhibitors such as imazatapyr and thifensulfuron-methyl; EPSP-synthesizing enzyme inhibitors; glutamine-synthesizing enzyme inhibitors; acetyl CoA carboxylase inhibitors; and bromoxynyl.

Examples of crops provided with resistance to herbicides by traditional breeding methods include Clearfield, registered trade name; Canola, provided with resistance to imidazolinone herbicide; STS soybean provided with resistance to sulfonylurea herbicide; and SR corn provided with resistance to acetyl CoA carboxylase inhibitors. Crops provided with resistance to acetyl CoA carboxylase inhibitors are described in Proc. Natl. Acad. Sci. USA 1990, 87, 7175. Mutated acetyl CoA carboxylase which develops resistance to acetyl CoA carboxylase inhibitors is reported in, for example, Weed Science 53:728-746, 2005. When a gene encoding this mutated acetyl CoA carboxylase is introduced by a genetic engineering technique, or when the mutation relating to supply of acetyl CoA carboxylase resistance to a gene encoding acetyl CoA carboxylase is introduced, crops are provided with resistance to the acetyl CoA carboxylase inhibition type herbicides.

Examples of the “crops” provided with resistance to herbicides by the genetic engineering technique include known breed varieties of corn provided with resistance to glyphosate and glyphosinate. Some of such breed varieties of corn have been commercialized under trade names of RoundupReady (registered trade name) and LibertyLink(registered trade name).

The above-mentioned “crops” include crops provided with capability of producing insecticidal toxins by a genetic engineering technique. Such insecticidal toxins include insecticidal proteins derived from Bacillus cereus and Bacillus popilliae; δ-endotoxins derived from Bacillus thuringiensis such as CrylAb, CrylAc, CrylF, CrylFa2, Cry2Ab, Cry3A, Cry3Bbl, and Cry9C, VIP1, VIP2, VIP3, and VIP3A; insecticidal proteins derived from Nematoda; toxins produced by animals such as scorpion toxins, spider toxins, bee toxins, and insect-specific neuron toxins; filamentous bacterium toxins; plant lectin; agglutininin; protease inhibitors such as trypsin inhibitor, serine protease inhibitor, patatin, cystatin, and papain inhibitor; ribosome-inactivating proteins (RIP) such as lysine, corn-RIP, abrin, saporin, and briodin; steroid metabolizing enzymes such as 3-hydroxysteroid oxidase, ecdisteroid-UDP-glucosyl transferase, and cholesterol oxidase; ecdyson inhibitor; HMG-COA reductase; ion channel inhibitors such as sodium channel and calcium channel inhibitors; juvenile hormone esterase; diuretic hormone receptor; stilbene syntase; dibenzyl syntase; chitinase; and glucanase. The insecticidal toxins include hybrid proteins of the above-mentioned proteins and the above-mentioned proteins in which portions of amino acids are defected or replaced. The hybrid proteins are produced by combining different domains of the above-mentioned insecticidal proteins by a genetic engineering technique. As a toxin of the above-mentioned proteins in which portions of amino acids are defected, CrylAb is known. Insecticidal toxins and “crops” provided with capabilities of producing insecticidal toxins by a genetic engineering technique are described in, for example, EP 0 374 753 A, WO 93/07278, WO 95/34656, EP 0 427 529 A, EP 451 878 A, and WO 03/052073.

“Crops” provided with capabilities of producing insecticidal toxins by a genetic engineering technique have resistance to attacks from Coleoptera harmful insects, Diptera harmful insects, and/or Lepidptera harmful insects.

Among “cops” provided with capabilities of producing insecticidal toxins by a genetic engineering technique, examples of commercialized cops include YieldGard, registered trade name (corn breed type developing toxins); YieldGard Rootworm, registered trade name (corn breed type developing Cry3Bbltoxin); YieldGard Plus, registered trade name (corn breed type developing CrylAb and Cry3Bbl toxins); Herculex I, registered trade name (corn breed type developing CrylFa2 toxin and phosphinotricin N-acetyltransferase (PAT) for providing resistance to glufosinate); NuCOTN33B, registered trade name (cotton breed type developing CrylAc toxin); Bollgard I, registered trade name (cotton breed type developing CrylAc toxin); Bollgard II, registered trade name (cotton breed type developing CrylAc and Cry2Ab toxins); VIPCOT, registered trade name (cotton breed type developing VIP toxin); NewLeaf, registered trade name (potato breed type developing Cry3Atoxin); NatureGard, registered trade name; Agrisure, registered trade name; GT Advantage (GA21, glyphosate-resistant character); Agrisure, trade name; CB Advantage (Bt11 Corn Borer (CB) character); and Proteca, trade name.

The above-mentioned “crops” include crops provided with capabilities of producing anti-pathogen substances by a genetic engineering technique. Examples of anti-pathogen substances produced by microorganism include PR proteins (PRPs, described in EP 0 392 225 A), ion channel inhibitors such as sodium channel inhibitors and calcium channel inhibitors (KP1, KP4, and KP6 toxins produced by virus; stilbene syntase; dibenzyl syntase; chitinase; glucanase; PR proteins; peptide antibiotics and antibiotics having heterorings; and proteins relevant to the plant disease resistance (described in WO 03/000906).

Examples of crops provided with capabilities of producing anti-pathogen substances by a genetic engineering technique include those described in EP 0 392 225 A, WO 95/33818, and EP 0 353 191 A.

In the present invention, insects causing harms on plant bodies after germination include harmful insects (harmful bugs and harmful mites) which eat and suck plant bodies. Specific examples of such insects are as follows.

### Hemiptera:

Delphacidae such as Laodelphax striatellus, Nilaparvata lugens, Sogatella furcifera and the like, Deltocephalidae such as Nephotettix cincticeps, Nephotettix virescens and the like, Aphididae such as Aphis gossypii, Myzus persicae, Brevicoryne brassicae, Macrosiphum euphorbiae, Aulacorthum solani, Rhopalosiphum padi, Toxoptera citricidus and the like, Pentatomidae such as Nezara antennata, Riptortus clavatus, Leptocorisa chinensis, Eysarcoris parvus, Halyomorpha mista, Lygus lineolaris and the like, Aleyrodidae such as Trialeurodes vaporariorum, Bemisia argentifolii and the like, Coccidae such as Aonidiella aurantii, Comstockaspis perniciosa, Unaspis citri, Ceroplastes rubens, Icerya purchasi and the like, Tingidae, Psyliidae and the like;

### Lepidoptera:

Pyralidae such as Chilo suppressalis, Tryporyza incertulas, Cnaphalocrocis medinalis, Notarcha derogate, Plodia interpunctella, Ostrinia furnacalis, Hellula undalis, Pediasia teterrellus and the like, Noctuidae such as Spodoptera litura, Spodoptera exigua, Pseudaletia separate, Mamestra brassicae, Agrotis ipsilon, Plusia nigrisigna, Thoricoplusia spp., Heliothis spp., Helicoverpa spp. and the like, Pieridae such as Pieris rapae and the like, Tortricidae such as Adoxophyes spp., Grapholita molesta, Leguminivora glycinivorella, Matsumuraeses azukivora, Adoxophyes orana fasciata, Adoxophyes sp., Homona magnanima, Archips fuscocupreanus, Cydia pomonella and the like, Gracillariidae such as Caloptilia theivora, Phyllonorycter ringoneella and the like, Carposinidae such as Carposina niponensis and the like, Lyonetiidae such as Lyonetia spp. and the like, Lymantriidae such as Lymantria spp., Euproctis spp. and the like, Yponomeutidae such as Plutella xylostella and the like, Gelechiidae such as Pectinophora gossypiella, Phthorimaea operculella and the like, Tineidae such as Hyphantria cunea and the like, Tineidae such as Tinea translucens, Tineola bisselliella and the like;

### Thysanoptera:

Thripidae such as Frankliniella occidentalis, Thrips parmi, Scirtothrips dorsalis, Thrips tabaci, Frankliniella intonsa, Frankliniella fusca and the like;

### Diptera:

Hylemya antique, Hylemya platura, Anopheles sinensis, Agromyza oryzae, Hydrellia griseola, Chlorops oryzae, Dacus cucurbitae, Ceratitis capitata, Liriomyza trifolii and the like;

### Coleoptera:

Epilachna vigintioctopunctata, Aulacophora femoralis, Phyllotreta striolata, Oulema oryzae, Echinocnemus squameus, Lissorhoptrus oryzophilus, Anthonomus grandis, Callosobruchus chinensis, Sphenophorus venatus, Popillia japonica, Anomala cuprea, Diabrotica spp., Leptinotarsa decemlineata, Agriotes spp., Lasioderma serricorne, Anthrenus verbasci), Tribolium castaneum, Lyctus brunneus, Anoplophora malasiaca, Tomicus piniperda and the like;

### Orthoptera:

Locusta migratoria, Gryllotalpa africana, Oxya yezoensis, Oxya japonica and the like;

### Hymenoptera:

Athalia rosae, Acromyrmex spp., Solenopsis spp. and the like;

### Acarina:

Tetranychidae such as Tetranychus urticae, Panonychus citri, Oligonychus spp. and the like, Eriophyidae such as Aculops pelekassi and the like, Tarsonemidae such as Polyphagotarsonemus latus and the like, Tenuipalpidae and the like.

In the present invention, insects causing harms on plants after germination are particularly Diptera harmful insects, Coleoptera harmful insects, and/or Lepidptera harmful insects.

The present invention will be illustrated in more detail by the following Examples, but the present invention is not limited thereto.

At first, examples of the present compound will be described below.

3-(2,6-difluorobenzoyl)-1-[2-fluoro-4-(1,1,2,2-tetrafluoroethoxy)phenyl]-1-methylurea (hereinafter, referred to as the present compound (1)) represented by the formula:

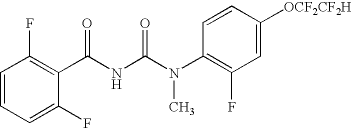

3-(2,6-difluorobenzoyl)-1-(4-trifluoromethoxy)phenyl)-1-methylurea (hereinafter, referred to as the present compound (2)) represented by the formula:

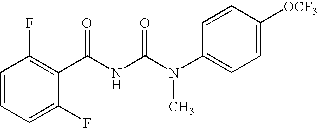

3-(2,6-difluorobenzoyl)-1-(4-chlorophenyl)-1-methylurea (hereinafter, referred to as the present compound (3)) represented by the formula:

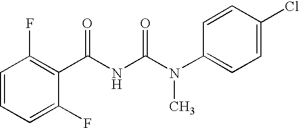

3-(2,6-difluorobenzoyl)-1-(4-chlorophenyl)-1,3-dimethylurea (hereinafter, referred to as the present compound (4)) represented by the formula:

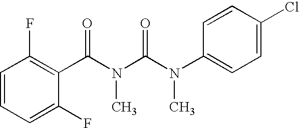

3-(2,6-difluorobenzoyl)-1-(3,5-dichloro-2,4-difluorophenyl)-1,3-dimethylurea (hereinafter, referred to as the present compound (5)) represented by the formula:

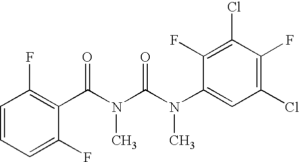

3-(2,6-difluorobenzoyl)-1-[2-fluoro-4-(1,1,2,2-tetrafluoroethoxy)phenyl)-1,3-dimethylurea (hereinafter, referred to as the present compound (6)) represented by the formula:

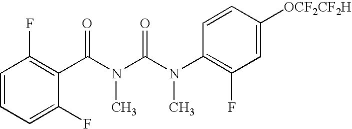

3-(2,6-difluorobenzoyl)-1-[2-fluoro-4-(trifluoromethyl)phenyl)-1,3-dimethylurea (hereinafter, referred to as the present compound (7)) represented by the formula:

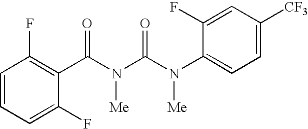

3-(2,6-difluorobenzoyl)-1-[2-fluoro-4-(trifluoromethyl)phenyl)-1-methylurea (hereinafter, referred to as the present compound (8)) represented by the formula:

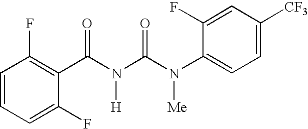

3-(2,6-difluorobenzoyl)-1-[4-(1,1,2,2-tetrafluoroethoxy)phenyl)-1-methylurea (hereinafter, referred to as the present compound (9)) represented by the formula:

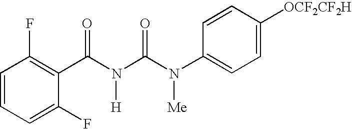

The above-mentioned compounds were produced by the following methods.

### SYNTHESIS EXAMPLE 1

A solution obtained by dissolving 0.75 g of 2,6-difluorobenzoyl isocyanate in 1.0 ml of diethyl ether was added to a solution obtained by dissolving 1.00 g of 2-fluoro-N-methyl-4-(1,1,2,2-tetrafluoroethoxy)aniline in 4.0 ml of diethyl ether with ice-cooling and the mixture was stirred at room temperature for 2 hours. After 10 ml of hexane was added to the reaction mixture, the mixture was filtered and the substance on the filter was dried to obtain 1.58 g of the present compound (1).

The present compound (1):

¹H-NMR (DMSO-d₆) δ (ppm): 3.20 (3H, s), 6.67-6.93 (1H, m), 7.09-7.20 (3H, m), 7.33-7.36 (1H, m), 7.45-7.53 (2H, m), 10.77 (1H, brs)

### SYNTHESIS EXAMPLE 2

A solution obtained by dissolving 0.57 g of 2,6-difluorobenzoyl isocyanate in 0.5 ml of diethyl ether was added to a solution obtained by dissolving 0.60 g of N-methyl-4-trifluoromethoxyaniline in 2.4 ml of diethyl ether under ice-cooling condition and the mixture was stirred at room temperature for 2 hours. After 6.0 ml of hexane was added to the reaction mixture, the mixture was filtered and the substance on the filter was dried to obtain 1.13 g of this compound (2).

The present compound (2):

¹H-NMR (DMSO-d₆) δ (ppm): 3.25 (3H, s), 7.12-7.16 (2H, m), 7.41-7.55 (5H, m), 10.68 (1H, brs)

### SYNTHESIS EXAMPLE 3

After 128 mg of sodium hydride was added to a solution obtained by dissolving 1.01 g of 3-(2,6-difluorobenzoyl)-1-[2-fluoro-4-(trifluoromethyl)phenyl]-1-methylurea in 10.0 ml of 1-methyl-2-pyrrolidone and stirred at about 2° C. for 30 minutes, 0.40 ml of methyl iodide was added to the mixture at 2° C. After the resulting mixture was stirred at 2 to 3° C. for 3 hours, a mixed solution of 10 ml of an aqueous saturate ammonium chloride solution and 10 ml of water was added under ice-cooling condition and extracted with 20 ml of ethyl acetate 3 times. The obtained organic layers were joined and washed with saturated salt water three times and the obtained product was dried with magnesium sulfate anhydride and concentrated under reduced pressure. The obtained residue was refined by silica gel column (ethyl acetate:chloroform: hexane=1:1:4) to obtain 0.79 g of the present compound (7).

The present compound (7):

¹H-NMR (DMSO, 80° C.) δ (ppm): 3.07 (3H, s), 3.28 (3H, s), 7.09-7.13 (2H, m), 7.50-7.60 (3H, m), 7.69-7.71 (1H, m)

### SYNTHESIS EXAMPLE 4

The present compound (8) was produced according to the same method as Synthesis Example 1.

The present compound (8):

¹H-NMR (DMSO) δ (ppm): 3.24 (3H, s), 7.12-7.16 (2H, m), 7.47-7.49 (1H, m), 7.51-7.67 (2H, m), 7.81-7.84 (1H, m), 10.89 (1H, brs).

### SYNTHESIS EXAMPLE 5

The present compound (9) was produced according to the same method as Synthesis Example 1.

The present compound (9):

¹H-NMR (CDCl₃) δ (ppm): 3.22 (3H, s), 5.81-6.09 (1H, m), 6.92-7.05 (2H, m), 7.32-7.55 (6H, m).

The present compound (3) is described in DE2123236 and can be produced by the method described therein. The present compound (4) and the present compound (5) are compounds described in JP 2-3659 A and can be produced by the methods described therein. The present compound (6) is described in JP 4-26667 A and can be produced by the method described therein.

The following Production Examples will illustrate the production of the composition of the present invention and the present seeds. All “parts” are by weight.

### PRODUCTION EXAMPLE 1

To 25 parts of each of the present compounds (1) to (9) are added 65 parts of cyclohexanone, 5 parts of NINATE 401-A and 5 parts of BRAUNONE BR-450 and the mixture is thoroughly mixed with stirring to obtain a 25% emulsion. The emulsion is diluted to 1/1000 with water to obtain a diluted solution. Seed rice is immersed in the diluted solution for 24 hours until the effective component is absorbed in the inside of the seed rice to obtain treated seeds.

### PRODUCTION EXAMPLE 2

A material for molding pellets is obtained by thoroughly mixing 25 parts of each of the present compounds (1) to (9) with 25 parts of clay, 25 parts of polyvinyl alcohol containing 50 parts of Sorgen TW-20, and 25 parts of water with stirring. Then, cabbage seeds are embedded in center of 20 mg of the above-obtained material for molding pellets, followed by molding in spherical shape to obtain treated seeds.

### PRODUCTION EXAMPLE 3

Flowable preparation containing 25% of the effective component is obtained by mixing 25 parts each of the present compounds (1) to (9), 20 parts of white carbon containing 50% (by weight) of polyoxyethylene alkyl ether sulfate ammonium salt, and 55 parts of water and finely pulverizing the resulting mixture by wet pulverization method. Cotton seeds are placed in to a pot (inner diameter 12 cm and depth 11 cm) made of a stainless steel which is equipped with two lift blades set on the opposite to each other in reversed directions so that seeds are lift up when the pot is rotated and tilted at an angle of 40 to 45 degree and mechanically rotated at 640 rpm, thereby well mixing the seeds and providing rolling-granulation action in the pot. Then, the flowable preparation is diluted to 1/100 with water and a handheld spraying apparatus is set toward the inside of the pot and the diluted flowable preparation is directly sprayed toward the center of the rotating granule layer of cotton seeds at supplied air pressure of 10 to 11 psi (69 to 76 kPa). Spraying is continues until the surfaces of the seeds become sticky to agglomerate the seeds. After the spraying apparatus is stopped, low pressure air is blown toward the seeds at room temperature by a nozzle installed in such a manner that air current can be sent toward the inside of the pot to quickly dry the seed coating. Thereafter, the air current for drying is shut and the spraying using the handheld type spraying apparatus is restarted. These spray drying cycles are repeated until a desired amount of the fluidizing suspension is applied to the seeds. Further, after exposing to ambient air at a low flow rate for 60 hours, the seed coating is completely dried to obtain treated seeds.

### TEST EXAMPLE 1

Pelletized seeds containing either one of the present compound (1) and (6) were produced according to the above-mentioned Production Example 2. The pelletized seeds were sowed in a plug cell tray (each cell volume: 27 ml, depth: 5.0 cm) filled with nursery soil and the plant was raised for 28 days after the sowing. After the root parts grown seedlings of cabbage were removed, the stems and leaves were put in a polyethylene cup (capacity 180 ml), 10 second-stage larvae of Plutella xylostella were released. The cup was kept at 25° C. for 7 days. Thereafter, the extent of feeding damages of the cabbage seedlings by larvae of Plutella xylostella was investigated and the case of treatment with the sample compounds (the treated group) and the case of un-treatment (the un-treated group) were compared to measure the damage-inhibition effect according to the following equation.

$$\begin{matrix}Damage \text{-} inhibiting \\ effect ( \% )\end{matrix} ( 1 - \frac{\begin{matrix}extent of feeding damage \\ in treated group\end{matrix}}{\begin{matrix}extent of feeding damage \\ un \text{-} treated group\end{matrix}} ) \times 100$$

As a result, in the treated group of the present compounds (1) and (6), the damage-inhibiting effect was respectively 90% or higher and thus the cabbage seedlings after germination were prevented from damages by Plutella xylostella.

As described hereinabove, treatment of seeds of a plant with a composition containing the present compound can prevent the plants from damages due to feeding by insect pests after germination.

1. A method for preventing a plant from damage by insect pests after germination of the plant which comprises the steps of:
treating seeds of the plant with a composition comprising a (N′-methyl)benzoylurea compound represented by the formula (I): 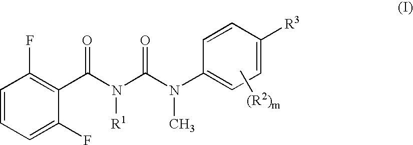
wherein R¹ denotes a hydrogen atom, an optionally halogenated C1-C6 alkyl group, an optionally halogenated C2-C6 alkenyl group, a C2-C6 alkynyl group, a C6-C14 aryl group, a C7-C11 aralkyl group, a C2-C6 alkoxyalkyl group, a C7-C14 aryloxyalkyl group, a C3-C6 dialkylaminoalkyl group, a C2-C6 alkylthioalkyl group, a C2-C6 alkylthioalkyl group, a C2-C6 alkylsulfinylalkyl group, a C2-C6 alkylsulfonylalkyl group, a C3-C9 alkoxyalkoxyalkyl group, a C2-C6 alkoxycarbonyl group, a C8-C12 aralkyloxycarbonyl group, a C3-C13 dialkylcarbamoyl group, an optionally halogenated C2-C6 alkylcarbonyl group, a formyl group, an optionally halogenated C1-C5 alkylsulfonyl group, or a C6-C10 arylsulfonyl group, R² denotes a halogen atom or an optionally halogenated C1-C4 alkyl group; R³ denotes a halogen atom, an optionally halogenated C1-C4 alkyl group, an optionally halogenated C1-C4 alkoxy group, an optionally halogenated C2-C6 alkoxyalkoxy group, an optionally halogenated C2-C4 alkenyloxy group, or an optionally halogenated C2-C4 alkynyloxy group, and m denotes an integer of 0 to 4, and
sowing the treated seeds, followed by cultivation.

2. The method according to claim 1, wherein the plant is selected from the group consisting of vegetables, corn, cotton, rice, sugar beet and soybean.

3. A method for producing treated seeds of a plant which comprises subjecting the seeds to a treatment with a composition comprising the (N′-methyl)benzoylurea compound represented by the formula (I) as defined in claim 1 so as to prevent the plant from damage by insect pests after germination.

4. The method according to claim 3, wherein the plant is selected from the group consisting of vegetables, corn, cotton, rice, sugar beet and soybean.

5. A composition for treating seeds of a plant so as to prevent the plant from damage by insect pests after germination comprising the (N′-methyl)benzoylurea compound represented by the formula (I) as defined in claim 1.

6. The composition according to claim 5, wherein the plant is selected from the group consisting of vegetables, corn, cotton, rice, sugar beet and soybean.

7. Seeds of a plant which are treated with a composition containing the (N′-methyl)benzoylurea compound represented by the formula (I) as defined in claim 1.

8. The seeds according to claim 7, wherein the plant is selected from the group consisting of vegetables, corn, cotton, rice, sugar beet and soybean.

9. Use of the (N′-methyl)benzoylurea compound represented by the formula (I) as defined in claim 1 for treatment of seeds of a plant so as to prevent the plant from damage by insect pests after germination.

10. The use according to claim 9, wherein the plant is selected from the group consisting of vegetables, corn, cotton, rice, sugar beet and soybean.
